(19) United States
(12) Patent Application Publication
(10) Pub. No.: US 2013/0034773 A1
(43) Pub. Date: Feb. 7, 2013

(54) SECONDARY CELL

(71) Applicants: Yoshihiro TSUKUDA, Osaka (JP); Satoshi OKANO, Osaka (JP)

(72) Inventors: Yoshihiro TSUKUDA, Osaka (JP); Satoshi OKANO, Osaka (JP)

(21) Appl. No.: 13/565,116

(22) Filed: Aug. 2, 2012

(30) Foreign Application Priority Data
Aug. 3, 2011 (JP) 2011-169974

(51) Int. Cl. H01M 2/08; H01M 2/30; H01M 2/04

(52) U.S. Cl. 429/179; 429/185

(57) ABSTRACT

Provided is a secondary cell in which the production takt time can be improved, airtightness of a cell canister is exhibited, cell capacity can be increased, and excellent handling properties can be obtained. A secondary cell comprising an electrode group (1); an exterior case (11); and a cell canister (10) comprising the exterior case (11) and a lid member (12), the interior of which canister being filled with an electrolyte, and airtightness being achieved; the secondary cell being constituted such that the cell canister (10) comprises a electrode group accommodating part and a peripheral edge section in which the exterior case (11) and the lid member (12) are double-seamed and sealed; and the peripheral edge section is provided so as to bulge outward from the electrode group accommodating part, and has an appropriately sized corner R corresponding to the plate thickness of plates to be double-seamed and exhibiting airtightness.

This application is based on Japanese Patent Application No. 2011-169974 filed Aug. 3, 2011, the entire contents of which are hereby incorporated by reference.

### BACKGROUND OF THE INVENTION

1. Field of the Invention

The present invention relates to a secondary cell, and particularly to a secondary cell having a cell canister structure that seals in a reliable manner a cell canister for accommodating an electrode group, is portable, and has excellent handling properties.

2. Description of Related Art

In recent years, lithium secondary cells have come to be used as cells for powering portable telephones, notebook PCs, and other portable electronic instruments because the cells have high energy density and are capable of being reduced in size and weight. Also, since a large capacity can be obtained, the cells are attracting interest as a motor-driving power source for electric vehicles (EVs), hybrid electric vehicles (HEVs), and similar vehicles, and as storage cells for storing electrical power.

The above-mentioned lithium secondary cell has a configuration in which an electrode group, in which a positive electrode plate and a negative electrode plate are arranged so as to face each other with a separator interposed therebetween, is accommodated within an exterior case constituting a cell canister, and the exterior case is filled with an electrolyte; the configuration comprising a positive electrode collector terminal linked to a plurality of positive electrode collector tabs of the positive electrode plate, a positive electrode external terminal electrically connected to the positive electrode collector terminal, a negative electrode collector terminal linked to a plurality of negative electrode collector tabs of the negative electrode plate, and a negative electrode external terminal electrically connected to the negative electrode collector terminal.

After the electrode group is accommodated in the exterior case and a connection is established with the external terminals, a lid member for sealing the opening section of the external case is attached, and sealed using laser welding or another welding method, a method for sealing in which a packing material is interposed, a sealing method in which a seam is formed at edges of the exterior case and the lid member, or another sealing method; and a hermetic seal is obtained.

Known electrode groups include wound-type electrode groups and layered-type electrode groups. A wound-type electrode group has a configuration in which a positive electrode plate, a negative electrode plate, and a separator interposed therebetween are integrally wound. A layered-type electrode group has a configuration in which pluralities of positive electrode plates and negative electrode plates are layered with separators interposed therebetween.

In a lithium secondary cell comprising a layered-type electrode group, an external case, adapted for accommodating a substantially cuboid electrode group in which pluralities of positive electrode plates and negative electrode plates are layered with separators interposed therebetween, is also substantially cuboid. A peripheral edge section surrounding the substantially cuboid accommodating part is sealed. Positive and negative external terminals are provided so as to protrude from both side sections that are oriented in opposing directions of the substantially cuboid accommodating part. Specifically, a substantially cuboid electrode group is accommodated in a substantially cuboid external case, the external case is filled with a non-aqueous electrolyte, the positive electrode collector terminal linked to the positive electrode collector tabs of the positive electrode plates is connected to the positive electrode external terminal, and the negative electrode collector terminal linked to the negative electrode collector tabs of the negative electrode plates is connected to the negative electrode external terminal.

In order to stabilize the cell performance of this secondary cell, it is important to apply a seal in a reliable manner and increase airtightness. For example, laser welding is performed to overlap the peripheral edge sections of the lid member and the external case, seal the entire periphery, and obtain a hermetic seal.

With the sealing method in which laser welding is used, the cost of the laser device is high and the sealing speed is low. Therefore, there has been proposed a rectangular lithium cell in which the sealing speed is increased using a double seaming method used for canned food and drinks (e.g., refer to Patent Citation 1: Japanese Patent No. 3482604).

In order to enlarge the capacity of the secondary cell, it is necessary to enlarge the area of each electrode plate to be layered, increase the number of layers, and increase the amount of electrolyte used to fill the cell; and the size of the cell canister also becomes greater. In order to create a large cell canister of such description, the plate thickness of the cell canister is also increased in order to obtain canister strength. For example, in a rectangular lithium cell described in Patent Citation 1, a stainless steel plate having a thickness of 0.3 mm is used; however, in a large layered-type secondary cell, the plate thickness is increased to about 0.8 to 1.0 mm.

As a result, with regard to accommodating a substantially cuboid electrode group in a substantially cuboid external case, double-seaming the peripheral edge sections, and applying a seal; where it had been possible to obtain a seal and maintain airtightness using plates having a thickness of 0.3 mm, using plates having a thickness of 0.8 mm to perform double-seaming under identical conditions results in the seal having insufficient airtightness, and a problem is presented.

With regard to sealing the upper section of the external case, in an instance in which a seal is applied around the outer periphery of the opening section, a configuration is present in which double seaming is applied at a corner R corresponding to a bend r of corner sections of the exterior case. In such an instance, when the plate thickness is small, airtightness is obtained even when the bend r and the corner R are similar. However, when the plate thickness is larger, and the corner R of the plate is as small as the bend r, it becomes difficult to apply a double seam while maintaining airtightness. Therefore, it shall be apparent that there exists an appropriate size for the corner R corresponding with the thickness of the plate constituting a cell canister by double seaming, and it is preferable to use a cell canister configuration comprising this appropriately sized corner R.

It is also possible to combine a plurality of secondary cells and constitute a large-capacity storage battery. It is therefore preferable that the cell canister of a secondary cell has a cell canister structure that can be readily carried and has excellent handling properties.

Also, the electrode group, whether in a configuration in which a wound-type electrode group has been flattened or in an instance of a layered-type electrode group, is preferably rectangular in plan view, i.e., substantially cuboid, due to the ease of manufacture and the larger electrode plate area. With regard also to an exterior case for accommodating a substantially cuboid electrode group, in order to store a predetermined amount of electrolyte, it is preferable that the accommodating part comprises a substantially cuboid shape in which the bend r of the corner sections is small.

Therefore, in order to improve the production takt time, it is preferable that the exterior case and the lid member constituting the cell canister be capable of being sealed so as to be airtight using the double-seaming method; and in order to increase the cell capacity, it is preferable to use a cell canister configuration comprising a substantially cuboid electrode group accommodating part, in which there is used an exterior case comprising a peripheral edge section that can be double-seamed so as to be airtight.

### SUMMARY OF THE INVENTION

With the above-mentioned problems in view, an object of the present invention is to provide a secondary cell in which the production takt time can be improved, it is possible to obtain airtightness in the cell canister, the cell capacity can be increased, and the handling properties are excellent.

In order to achieve the above-mentioned object, the present invention is a secondary cell, comprising: an electrode group, made by layering a positive electrode plate, a negative electrode plate, and a separator; an exterior case for accommodating the electrode group; and a lid member for hermetically sealing the exterior case; an interior of a cell canister configured using the exterior case and the lid member being filled with an electrolyte; the cell canister comprising a substantially cuboid electrode group accommodating part, and a peripheral edge section in which the exterior case and the lid member are double-seamed and sealed; and the peripheral edge section being provided so as to bulge outward from the electrode group accommodating part, and having a corner R that is greater than a bend r of a corner section of the exterior case.

According to this configuration, the peripheral edge section is provided so as to bulge outward from the substantially cuboid electrode group accommodating part, and the bulging peripheral edge sections are double-seamed at a corner R that is greater than the bend r of the exterior case; therefore, it is possible to form double-seamed sections capable of exhibiting a predetermined degree of airtightness, maintain a high energy density, and increase the cell capacity. Also, since the secondary cell has a large corner R, it is possible to perform double-seaming work rapidly. The secondary cell can also be readily carried by holding the outwardly bulging double-seamed sections. In other words, it is possible to obtain a secondary cell in which the production takt time can be improved, airtightness in a cell canister can be obtained, the cell capacity can be increased, and the handling properties are excellent.

In the secondary cell of the invention according to the aspect described above, the corner R is equal to or greater than double the bend r. According to this aspect, it is possible to reduce the bend r of the exterior case, enable the substantially cuboid electrode group to be readily accommodated, increase the electrolyte storage capacity, enlarge the corner R of the peripheral edge sections that are to be double-seamed, improve the production takt time, and improve the airtightness.

In the secondary cell of the invention according to the aspect described above, the corner R is a corner R corresponding to the plate thickness of the double-seamed exterior case and lid member, and exhibiting airtightness. According to this aspect, the corner R of the peripheral edge section to be double-seamed has a predetermined size corresponding to the plate thickness of the exterior case and the lid member, therefore making it possible to form a double-seamed section capable of exhibiting sufficient airtightness. It is also possible to perform the double-seaming work rapidly.

In the secondary cell of the invention according to the aspect described above, the double-seamed section is provided so as to bulge outward from the electrode group accommodating part and protrude upward, and forms a step having a predetermined chuck wall height and being of a size allowing the electrode group accommodating part to fit therein. According to this aspect, an electrode group accommodating part (exterior case) of another secondary cell fits into the step; therefore, a plurality of secondary cells can be readily stacked, and the handling properties are improved.

In the secondary cell of the invention according to the aspect described above, the peripheral edge section is provided upon four peripheral sides of the electrode group accommodating part being extended. According to this aspect, the peripheral edge section is formed so as to protrude around the electrode group accommodating part, which is rectangular in plan view, and the secondary cell can therefore be readily handled by holding the peripheral edge section.

In the secondary cell of the invention according to the aspect described above, the cell canister has an electrode group accommodating part provided with positive and negative external terminals installed respectively on two opposing side surfaces, the electrode group accommodating part fashioned to a rectangular profile having long sides and short sides; and the peripheral edge section is provided upon primarily the short sides to which the external terminals are provided being extended. According to this aspect, the secondary cell can be readily handled by holding the peripheral edge sections on the sides to which the external terminals are provided. Also, the peripheral edge sections on the external terminal-sides bulge out, and therefore do not inadvertently touch the external terminals.

In the secondary cell of the invention according to the aspect described above, the cell canister has an electrode group accommodating part provided with positive and negative external terminals installed respectively on two opposing side surfaces, the electrode group accommodating part fashioned to a rectangular profile having long sides and short sides; and the peripheral edge section is provided upon primarily the long sides to which the external terminals are not provided being extended. According to this aspect, the secondary cell can be readily handled by holding the peripheral edge sections on the sides to which the external terminals are not provided.

In the secondary cell of the invention according to the aspect described above, the plate thickness of the exterior case and the plate thickness of the lid member are a thickness of about 0.8 to 1.0 mm at which a predetermined cell canister strength is exhibited, the corner R being about 15 mm or more. According to this aspect, the cell canister is formed from the exterior case and the lid member having a plate thickness of 0.8 mm to 1.0 mm, therefore making it possible to obtain canister strength. Also, since double-seaming is performed at a corner R greater than or equal to about 15 mm, it is possible to obtain an airtight seal while maintaining canister strength.

### BRIEF DESCRIPTION OF THE DRAWINGS

FIG. 1 is a schematic cross-section view used to illustrate an overview of a secondary cell according to the present invention;

FIG. 2 is a schematic plan view illustrating a first embodiment of the secondary cell according to the present invention;

FIG. 3 is a schematic plan view illustrating a second embodiment of the secondary cell according to the present invention;

FIG. 4 is a schematic plan view illustrating a third embodiment of the secondary cell according to the present invention;

FIG. 5 is an enlargement of a double-seamed section;

FIG. 6 is an exploded perspective view of the secondary cell;

FIG. 7 is an exploded perspective view of an electrode group provided to the secondary cell;

FIG. 8 is a perspective view showing a completed secondary cell; and

FIG. 9 is a schematic cross-section view of the electrode group.

### DETAILED DESCRIPTION OF PREFERRED EMBODIMENTS

An embodiment of the present invention will now be described with reference to the accompanying drawings. Constituent components that are identical display identical numerals, and a detailed description will be omitted as appropriate.

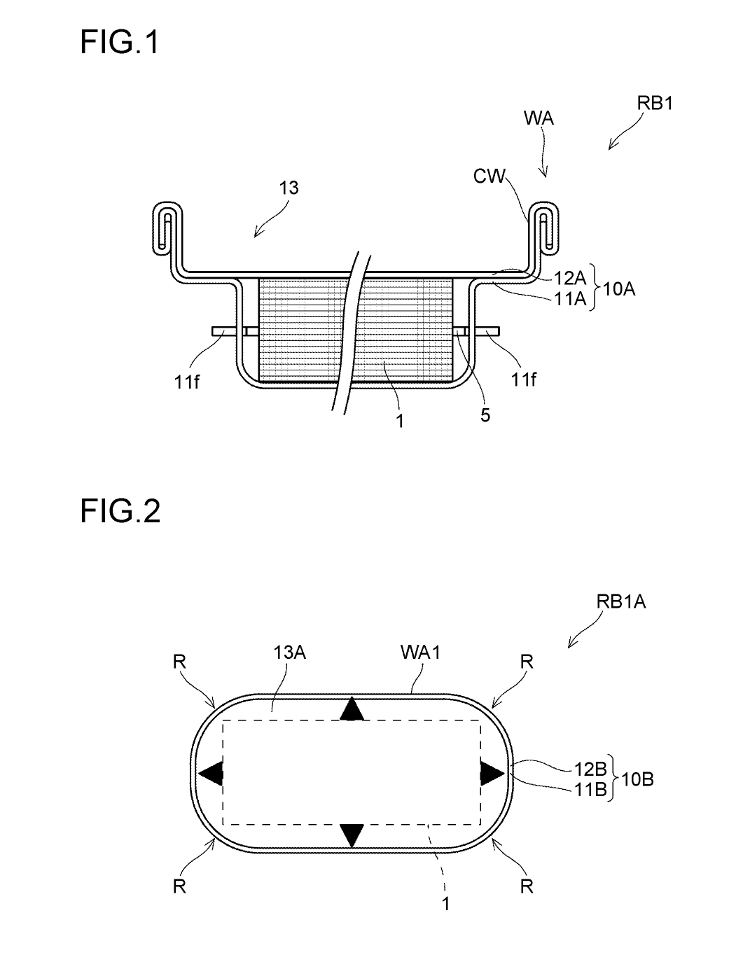

A description shall now be given for a lithium secondary cell as a secondary cell according to the present invention. For example, a secondary cell RB1 according to the present embodiment shown in FIG. 1 is a layered-type lithium secondary cell. A layered-type electrode group 1, in which pluralities of positive electrode plates and negative electrode plates are layered with separators interposed therebetween, is accommodated in a cell canister 10A configured using an exterior case 11A and a lid member 12A.

The secondary cell RB1 has a configuration in which the electrode group 1, in which positive electrode plates and negative electrode plates are arranged on either side of the separators, is accommodated in the exterior case 11A constituting the cell canister 10A; and the exterior case 11A is filled with an electrolyte; the configuration comprising collector terminals 5 linked to a plurality of collector tabs of the positive and negative electrode plates, and external terminals 11f that are electrically connected to the collector terminals.

The electrode group 1 is accommodated in the exterior case 11A, and a connection is established with the external terminals 11f; then, the lid member 12A for sealing an opening section of the exterior case 11A is attached, e.g., a double-seamed section WA such as that shown in the drawing is provided, and sealing is performed (a hermetic seal is obtained).

With regard to a method for sealing the exterior case and the lid member, laser welding or another welding method is possible; however, a sealing method using double seaming, in which a peripheral edge section of the exterior case and a peripheral edge section of the lid member are laid over one other, folded over, tucked in, and joined, is beneficial in terms of productivity and cost.

In an instance in which joining is performed by a welding method, it is preferable that the two members to be joined are made from an identical member. However, performing joining using the double-seaming method allows the material forming the two members to be joined to differ (e.g., stainless steel and aluminum), and is therefore preferable as the materials can be selected from a larger variety.

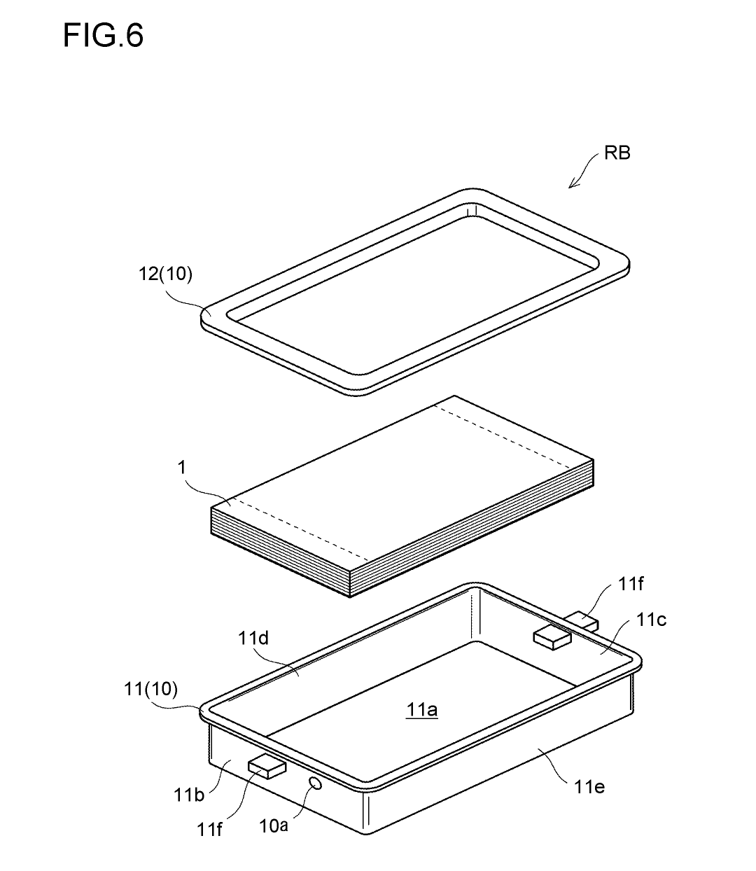

Next, a description will be given for a specific configuration of a layered-type lithium secondary cell RB and an electrode group 1 with reference to FIGS. 6 through 9.

As shown in FIG. 6, a layered-type lithium secondary cell RB is rectangular in plan view, and comprises an electrode group 1 in which positive electrode plates, negative electrode plates, and separators, each of which are rectangular, are layered. A configuration is present in which the electrode group 1 is accommodated in a cell canister 10 comprising a lid member 12 and an exterior case 11, which has a box shape comprising a bottom section 11a and side sections 11b through 11e; and charging/discharging is performed from external terminals 11f provided to side surfaces (e.g., two opposing side surfaces of side sections 11b, 11c) of the exterior case 11.

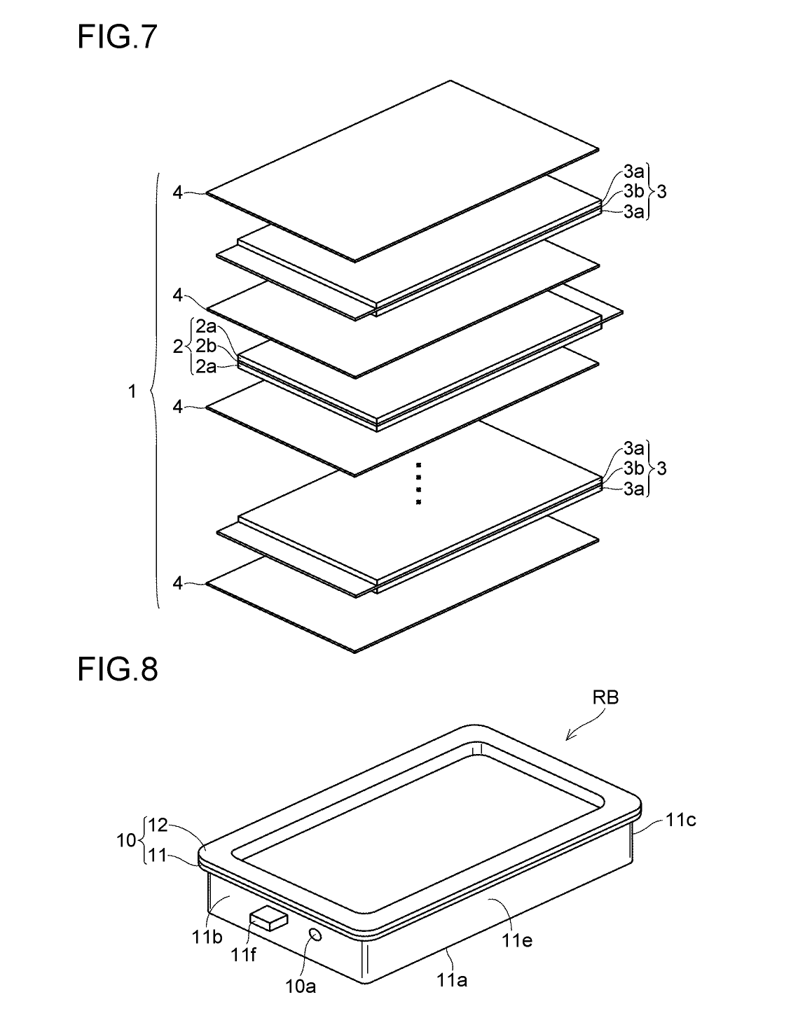

The electrode group 1 has a configuration in which pluralities of positive electrode plates and negative electrode plates are layered with separators interposed therebetween. As shown in FIG. 7, positive electrode plates 2, in which a positive electrode active material layer 2a made from a positive electrode active material is formed on both surfaces of a positive electrode collector 2b (e.g., an aluminum foil); and negative electrode plates 3, in which a negative electrode active material layer 3a made from a negative electrode active material is formed on both surfaces of a negative electrode collector 3b (e.g., a copper foil); are layered with separators 4 interposed therebetween.

The separators 4 are used to obtain insulation between the positive electrode plates 2 and the negative electrode plates 3. However, movement of lithium ions between the positive electrode plates 2 and the negative electrode plates 3 is possible via the electrolyte filling the exterior case 11.

Examples of the positive electrode active material in the positive electrode plates 2 include an oxide containing lithium (e.g., LiFePO₄, LiCoO₂, LiNiO₂, LiFeO₂, LiMnO₂, LiMn₂O₄), or a compound in which a part of a transition metal in an oxide of such description is replaced with another metal element. Notably, using, as the positive electrode active material, a substance in which 80% or more of lithium contained in the positive electrode plates 2 can be utilized for a cell reaction during normal use makes it possible to improve safety in relation to adverse events related to overcharging.

A substance containing lithium, or a substance into which lithium can be inserted and from which lithium can be detached, is used for the negative electrode active material in the negative electrode plates 3. In particular, in order to obtain a high energy density, it is preferable to use a substance in which the intercalation/deintercalation potential of lithium is near the oxidation/reduction potential of metallic lithium. Typical corresponding examples include particulate (flaked, lumped, fibriform, whiskered, spherical, pulverulent, or otherwise-configured) natural graphite or artificial graphite.

An electroconductive material, a thickener, a bonding material, or a similar material may also be contained in the positive electrode plate 2 or the negative electrode plate 3 in addition to the positive electrode active material in the positive electrode plates 2 or the negative electrode active material in the negative electrode plates 3. There are no particular limitations on the electroconductive material as long as it is an electron-conducting material that does not adversely affect the cell performance of the positive electrode plates 2 and the negative electrode plates 3; examples that can be used include carbon black, acetylene black, ketjen black, graphite (natural graphite, artificial graphite), carbon fiber, or another carbonaceous material; or an electroconductive metal oxide.

Examples of the thickener that can be used include polyethylene glycols, celluloses, polyacrylamides, poly N-vinylamides, and poly N-vinylpyrrolidones. The bonding material plays the role of binding active material particles and electroconductive material particles; examples that can be used include polyvinylidene fluoride, polyvinyl pyridine, polytetrafluoroethylene, or another fluorine-based polymer; polyethylene, polypropylene, or another polyolefin-based polymer; or styrene-butadiene rubber.

A microporous polymer film is preferably used for the separators 4. Specifically, a film made from nylon, cellulose acetate, nitrocellulose, polysulfone, polyacrylonitrile, polyvinylidene fluoride, polypropylene, polyethylene, polybutene, or another polyolefin polymer can be used.

An organic electrolyte is preferably used for the electrolyte. Specifically, as an organic solvent of the organic electrolyte, ethylene carbonate, propylene carbonate, butylene carbonate, diethyl carbonate, dimethyl carbonate, methyl ethyl carbonate, γ-butyrolactone, or another ester; tetrahydrofuran, 2-methyl tetrahydrofuran, dioxane, dioxolane, diethyl ether, dimethoxyethane, diethoxyethane, methoxyethoxyethane, or another ether; dimethyl sulfoxide; sulfolane; methyl sulfolane; acetonitrile; methyl formate; methyl acetate; or a similar substance can be used. These organic solvents may be used as a standalone or as a mixture of two or more types.

An electrolyte salt may be included in the organic solvent. Examples of the electrolyte salt include lithium perchlorate (LiCiO₄), lithium fluoroborate, lithium phosphate hexafluoride, trifluoromethanesulfonate (LiCF₃SO₃), lithium fluoride, lithium chloride, lithium bromide, lithium iodide, lithium tetrachloroaluminate, or another lithium salt. These electrolyte salts may be used as a standalone or as a mixture of two or more types.

There are no specific limitations as to the concentration of the electrolyte salt; however, the concentration is preferably approximately 0.5 to approximately 2.5 mol/L, and further preferably approximately 1.0 to 2.2 mol/L. In an instance in which the concentration of the electrolyte salt is less than approximately 0.5 mol/L, there is a risk of a decrease in the carrier concentration in the electrolyte and an increase in the resistance of the electrolyte. In an instance in which the concentration of the electrolyte salt is higher than approximately 2.5 mol/L, there is a risk of the degree of dissociation of the salt itself decreasing, and the carrier concentration in the electrolyte being prevented from increasing.

The cell canister 10 comprises the exterior case 11 and the lid member 12, and is made from iron, nickel-plated iron, stainless steel, aluminum, or a similar material. In the present embodiment, as shown in FIG. 8, the cell canister 10 is formed so that the outer profile is substantially a flattened rectangle when the exterior case 11 and the lid member 12 have been combined.

The exterior case 11 has a box shape having a bottom section 11a equipped with a substantially rectangular bottom surface, and four surfacial side sections 11b through 11e provided upright from the bottom section 11a; the electrode group 1 being accommodated in the box-shaped interior. The electrode group 1 comprises a positive electrode collector terminal linked to the collector tabs of the positive electrode plates and a negative electrode collector terminal linked to the collector tabs of the negative electrode plates, and external terminals 11f electrically connected to the collector tabs are provided to individual side sections of the exterior case 11. The external terminals 11f are provided, e.g., at two locations, which are two side sections 11b, 11c that are opposite each other. Numeral 10a represents a liquid inlet, and the electrolyte is injected from here.

The electrode group 1 is accommodated in the exterior case 11, and each of the collector terminals is connected to an external terminal; or, each of the external terminals is connected to a collector terminal of the electrode group 1, the electrode group 1 is accommodated in the exterior case 11, and the external terminals are adhered to predetermined portions of the exterior case; then, the lid member 12 is immobilized on opening edges of the exterior case 11. As a result, the electrode group 1 is sandwiched between the bottom section 11a of the exterior case 11 and the lid member 12, and the electrode group 1 is held in the interior of the cell canister 10. Immobilizing the lid member 12 with respect to the exterior case 11 is performed using the aforementioned double seaming, laser welding, or a similar method. The collector terminals and the external terminals may be connected using ultrasonic welding, laser welding, resistance welding, or another welding method; or otherwise using an electroconductive adhesive or the like.

As described above, the layered-type secondary cell according to the present embodiment has a configuration comprising the electrode group 1 in which pluralities of the positive electrode plates 2 and the negative electrode plates 3 are layered with the separators 4 interposed therebetween; the exterior case 11 for accommodating the electrode group 1, the exterior case 11 being filled with the electrolyte; the external terminals 11f provided to the exterior case 11; positive and negative collector terminals for electrically connecting the positive and negative electrode plates and the external terminals 11f; and the lid member 12 fixed on the exterior case 11.

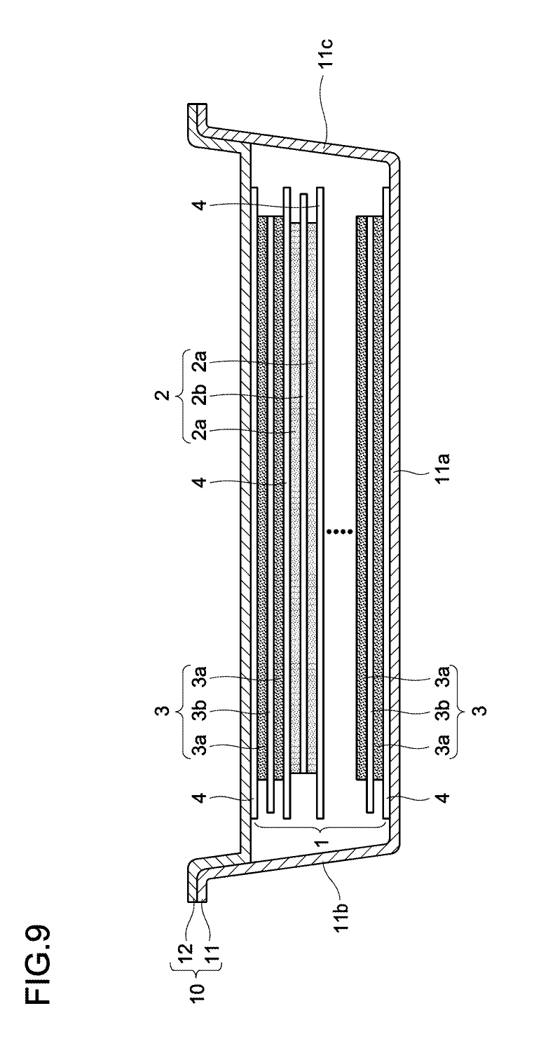

For the electrode group 1 accommodated in the exterior case 11, e.g., as shown in FIG. 9, the positive electrode plates 2, in which the positive electrode active material layers 2a are formed on both surfaces of the positive electrode collector 2b; and the negative electrode plates 3, in which the negative electrode active material layers 3a are formed on both surfaces of the negative electrode collector 3b; are layered with the separators 4 interposed therebetween; and separators 4 are further installed on both end surfaces. A configuration is also possible in which, instead of the separators 4 on both end surfaces, a resin film made from the same material as the separators 4 is wound, and the electrode group 1 is covered using the resin film having an insulating property. Either instance results in a configuration in which a member having electrolyte-permeating properties and insulating properties is layered on an upper surface of the layered electrode group 1. It therefore becomes possible to allow this surface to come into direct contact with the lid member 12, or to be held down through the lid member at a predetermined pressure.

The lid member 12 may have a tabular in shape, or dish-shaped so as to fit into the interior of the canister as shown; an appropriate shape is used depending on the plate thickness of the electrode group 1 to be accommodated. Using a dish-shaped lid member 12 makes it possible to reliably prevent the lid member from moving, therefore facilitating the welding or seaming work. It is also possible to readily respond to any changes in the plate thickness of the electrode group 1 to be accommodated by modifying the size of the recess in the dish shape. A dish shape is also preferable because the strength of the lid member 12 and the strength of the cell canister can be enhanced.

In order to enlarge the capacity of the secondary cell of such configuration, it is necessary to enlarge the area of the electrode plates that are layered, increase the number of layers, and increase the amount of electrolyte used to fill the cell canister. It is preferable that the electrode group 1 have a rectangular, substantially cuboid shape, and the electrode group accommodating part similarly have a substantially cuboid shape.

In order to increase the cell performance of the secondary cell, it is preferable that the airtightness of the cell canister is enhanced and the energy density is increased; and it is preferable that a configuration is present in which a large-sized electrode group can be accommodated and a sufficient amount of electrolyte can be introduced. In order to increase productivity, it is preferable that the processing speed, at which the lid member 12 and the exterior case 11 constituting the cell canister are joined and sealed, can be increased. Therefore, in the present embodiment, sealing is performed by double-seaming, through which, compared to welding, the cost can be reduced, the speed can be increased, and a higher airtightness can be obtained.

However, when the exterior case 11 and the lid member 12 are sealed by double-seaming, it is preferable that a corner R corresponding to the plate thickness is present. Only by a corner R having a predetermined size being provided and double-seaming being applied will a predetermined degree of airtightness be obtained. In order to obtain sufficient case strength, a plate thickness of the electrode group accommodating part for accommodating the electrode group, i.e., the plate thickness of the exterior case, that is equal to or greater than a predetermined thickness (e.g., 0.8 mm to 1.0 mm) is necessary; and it is desirable that double-seaming be performed at an appropriately sized corner R corresponding to this plate thickness.

Accordingly, in the present embodiment, the electrode group accommodating part is substantially cuboid, and the double-seamed section is one that is provided with a corner R having a predetermined size corresponding to the thickness of the plates to be double-seamed. Specifically, a configuration is present in which the peripheral edge section to be double-seamed is provided so as to bulge outward, and double-seaming is performed on the bulging peripheral edge section at a corner R that is greater than the bend r of the exterior case 11. A configuration in which the peripheral edge section of the exterior case 11 bulges outward also makes it possible to readily carry the secondary cell by holding the bulging double-seamed section. Specifically, it is possible to obtain a secondary cell in which the production takt can be improved, airtightness in a cell canister can be obtained, the cell capacity can be increased, and the handling properties are excellent.

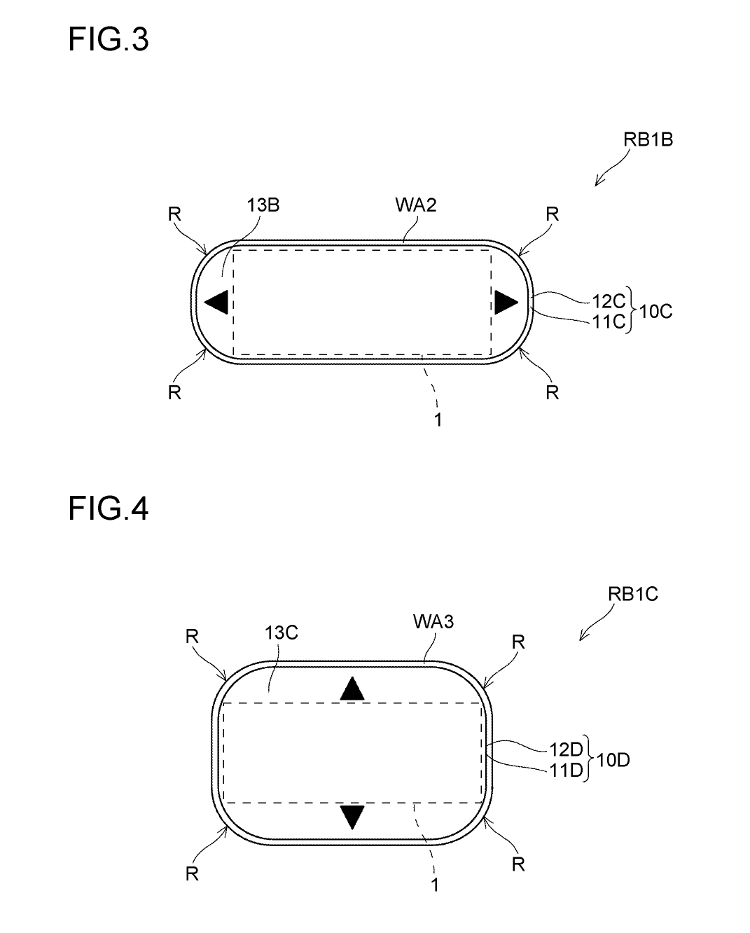

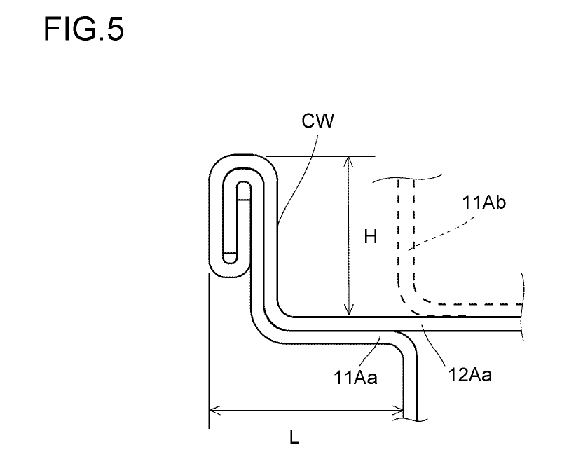

Next, specific embodiments of the secondary cell will be described with reference to FIGS. 2 through 4. FIG. 2 shows a secondary cell RB1A according to a first embodiment, FIG. 3 shows a secondary cell RB1B according to a second embodiment, and FIG. 4 shows a secondary cell RB1C according to a third embodiment.

The secondary cell RB1A according to the first embodiment shown in the schematic plan view of FIG. 2 comprises an electrode group 1, which is rectangular in plan view, in which pluralities of positive electrode plates and negative electrode plates are layered with separators interposed therebetween; and a cell canister 10B configured using an exterior case 11B for accommodating the electrode group and a lid member 12B for hermetically sealing the exterior case 11B. The cell canister 10B comprises peripheral edge sections for double-seaming and sealing the exterior case 11B and the lid member 12B. The peripheral edge sections, which bulge outward from the electrode group accommodating part, are indicated in the drawing by black triangles. Specifically, in the secondary cell RB1A, peripheral edge sections on four sides of the electrode group accommodating part are caused to bulge outward and are double-seamed. Four corner sections are configured so as to have an appropriately sized corner R in correspondence with the plate thickness so that sufficient airtightness is obtained.

While the peripheral edge sections of the secondary cell, which is rectangular in plan view, have four corner sections, methods for providing a corner R having a predetermined size so as to surround the electrode group 1, which is rectangular in plan view, include, other than the method according to the present embodiment in which the corner R is provided by extending all peripheral edge sections in the four directions of upward, downward, leftward, and rightward in the drawing, a method in which the peripheral edge sections are provided so as to extend primarily toward either the top and bottom or the left and right.

For example, in a secondary cell RB1A having a configuration in which all of the peripheral edge sections on the four sides of the electrode group accommodating part are extended, a double-seamed section WA1 is formed so as to surround the electrode group 1 at a distance, and the peripheral edge sections are formed so as to protrude in four directions around the electrode group accommodating part, which is rectangular in plan view. Therefore, the peripheral edge sections extending in four directions can be readily held and handled. Also, the electrode group accommodating part is sized so as to readily accommodate the electrode group 1, which is substantially cuboid; therefore, a sufficient amount of electrolyte can be introduced.

The double-seamed section WA1 is provided so as to bulge outward from the electrode group accommodating part and protrude upward, and forms a step 13A having a predetermined chuck wall height (see step 13 and chuck wall CW shown in FIG. 1), and being of a size allowing the electrode group accommodating part to fit therein. According to this configuration, an electrode group accommodating part (exterior case) of another secondary cell fits into the step 13A; therefore, a plurality of secondary cells RB1A can be readily stacked, and the handling properties are improved.

FIG. 3 shows a secondary cell RB1B according to the second embodiment, in which the peripheral edge sections are extended in two directions, i.e., toward the left and right, indicated by black triangles in the drawing. Specifically, a cell canister 10C of the secondary cell RB1B comprises an electrode group accommodating part comprising positive and negative external terminals installed respectively on two opposing side surfaces, the electrode group accommodating part fashioned to a rectangular profile having long sides and short sides. The peripheral edge sections are provided upon primarily the short sides to which the external terminals are provided being extended. According to this configuration, the secondary cell can be readily handled by holding the peripheral edge sections on the sides to which the external terminals are provided. Also, the peripheral edge sections on the external terminal-sides bulge out, and therefore do not inadvertently touch the external terminals.

In the secondary cell RB1B, again, a lid member 12C and an exterior case 11C forming the cell canister 10C are caused to bulge outward from the electrode group accommodating part and protrude upward, and a double-seamed section WA2 is provided. Therefore, a configuration is obtained in which an electrode group accommodating part (exterior case) of another secondary cell fits into a step 13B formed by the double-seamed section WA2, making it possible to readily stack a plurality of secondary cells RB 1B.

FIG. 4 shows a secondary cell RB1C according to the third embodiment in which the peripheral edge sections are extended in two directions, i.e., toward the top and the bottom, indicated by black triangles in the drawing. Specifically, a cell canister 10D of the secondary cell RB1C comprises an electrode group accommodating part comprising positive and negative external terminals installed respectively on two opposing side surfaces, the electrode group accommodating part being fashioned to a rectangular profile having long sides and short sides. The peripheral edge sections are provided upon primarily the long sides to which the external terminals are not provided being extended. According to this configuration, the secondary cell can be readily handled by holding the peripheral edge sections on the sides to which the external terminals are not provided.

In the secondary cell RB1C, again, a lid member 12D and an exterior case 11D forming the cell canister 10D are caused to bulge outward from the electrode group accommodating part and protrude upward, and a double-seamed section WA3 is provided. Therefore, a configuration is obtained in which an electrode group accommodating part (exterior case) of another secondary cell fits into a step 13C formed by the double-seamed section WA3, making it possible to readily stack a plurality of secondary cells RB1C.

The above-mentioned corner R is provided so as to surround the electrode group accommodating part accommodating the electrode group 1; therefore, the electrode group accommodating part may be substantially cuboid. Specifically, the bend r of corner parts of the exterior case may be small, and may be about r2 to r7. Also, the corner R of the peripheral edge sections provided so as to bulge outward from the exterior case may be a corner R that is greater (e.g., double or greater) than the bend r. Since the corner R is provided so as to surround the electrode group accommodating part, the corner R does not represent a factor impeding the shape or size of the electrode group 1. When a test was performed in relation to the size of the corner R using a variety of plate thicknesses, it was revealed that the size of the corner R is preferably equal to or greater than about 15 mm when the cell canister has a plate thickness of 0.8 mm to 1.0 mm, i.e., when the exterior case (11A through 11D) and the lid member (12A through 12D) are made from a plate having a thickness of 0.8 mm to 1.0 mm.

Specifically, it was found that when the plate thickness is 0.8 to 1.0 mm and the bend r is about 5 mm, the corner R preferably measured about 15 to 20 mm, which is greater than double the bend r. According to this configuration, it is possible to reduce the bend r of the exterior case, enable the substantially cuboid electrode group to be readily accommodated, increase the electrolyte storage capacity, enlarge the corner R of the peripheral edge sections that are to be double-seamed, improve the production takt time, and improve the airtightness.

For example, with reference to FIG. 5, regarding the bulge length L and the chuck wall height H when an exterior case 11Aa and a lid member 12Aa having a plate thickness of 0.8 mm are used, the corner R measures 15 mm, and double-seaming is applied, it was found that double-seaming can be applied in a rapid and reliable manner when the bulge length L is approximately 15 to 20 mm and the chuck wall height H is about 10 to 15 mm.

Also, a configuration is obtained in which an electrode group accommodating part (exterior case 11Ab) of another secondary cell fits into a step formed by the chuck wall CW formed in the double-seamed section, as shown in the drawing; therefore, a plurality of secondary cells can be readily stacked. Also, the secondary cell can be readily handled by holding the double-seamed chuck wall CW section, a bulging length section, and other peripheral edge sections.

Next, a description will be given for a lithium secondary cell that has been created in reality.

### Example

### Creating the Positive Electrode Plates

LiFePO₄ (88 wt %), used as a positive electrode active material; carbon black (5 wt %), used as an electroconductive material; styrene-butadiene rubber (6 wt %), used as a binder (bonding material); and carboxymethyl cellulose (1 wt %), used as a thickener, were mixed; N-methyl-2-pyrrolidone was added as appropriate as a solvent, and a slurry was prepared; and this slurry was uniformly coated on both surfaces of an aluminum foil (thickness: 20 nm) used as a positive electrode collector, and dried. The resulting article was compressed using a roll press and cut to a predetermined size, and plate-shaped positive electrode plates 2 were created.

The positive electrode plates that were created measured 150 mm×340 mm and had a thickness of 400 nm. Fifty of such positive electrode plates 2 were used.

### [Creating the Negative Electrode Plates]

Natural graphite (98 wt %), used as a negative electrode active material; styrene-butadiene rubber (1 wt %), used as a binder (bonding material); and carboxymethyl cellulose (1 wt %), used as a thickener, were mixed; N-methyl-2-pyrrolidone was added as appropriate as a solvent, the materials were dispersed, and a slurry was prepared. This slurry was uniformly coated on both surfaces of a copper foil (thickness: 16 nm) used as a negative electrode collector, and dried. The resulting article was compressed using a roll press and cut to a predetermined size, and plate-shaped negative electrode plates 3 were created.

The negative electrode plates that were created measured 154 mm×344 mm and had a thickness of 350 μm. Fifty-one of such negative electrode plates 3 were used.

102 sheets of polyethylene film measuring 160 mm×350 mm and having a thickness of 20 μm were created as separators.

### [Creating a Non-Aqueous Electrolyte]

1.2 mol/L of LiPF₆ was dissolved in a mixture (solvent) in which ethylene carbonate (EC) and diethyl carbonate (DEC) were mixed at a volume ratio of 30:70, and a non-aqueous solution was prepared.

### [Creating the Cell Canister]

A nickel-plated iron plate having a thickness of 0.8 mm was used as the material for fabricating the exterior case and the lid member constituting the cell canister. The cell canister size used as a standard was one in which the inner dimensions of the longitudinal direction (long side)×lateral direction (short side)×depth of the electrode group accommodating part of the exterior case measured 380 mm×170 mm×40 mm, and the bend r was about 5 mm. Joining of the case with the lid member was performed using a double-seam having a step in which the chuck wall height was 12 mm. The shape of the peripheral edge was such that the bulge length after double-seaming measured about 15 mm and the corner R measured about 20 mm. A cell canister of a rectangular lithium secondary cell having an inlet lid that can be opened or closed was created.

### [Assembling the Secondary Cell]

The positive electrode plates and the negative electrode plates were alternately layered with the separators interposed therebetween. An electrode group (layered body) was built so as to have a configuration in which 50 positive electrode plates, 51 negative electrode plates, and 102 separators are layered so that negative electrode plates are positioned on the outside of the positive electrode plates and so that separators are the outermost layer.

As mentioned earlier, the separators interposed between the positive and negative electrode plates measured 160 mm×350 mm, which is slightly larger than the positive electrode plates (150 mm×340 mm) and the negative electrode plates (154 mm×344 mm). It is thereby possible to reliably cover the active material layers formed on the positive electrode plates and the negative electrode plates. A connection piece of a collector member (collector terminal) was connected to each of an exposed-collector section of the positive electrode and an exposed-collector section of the negative electrode.

The electrode group to which the collector terminals are connected was accommodated in the exterior case; the collector terminals and the external terminals were connected; the lid member was attached; the peripheral edge sections on four sides when the exterior case and the lid member are combined were double-seamed and sealed; and the non-aqueous electrolyte was depressurized and injected through the inlet by a vacuum injection step. After injection, the inlet was hermetically sealed, and the secondary cell RB1 (RB1A through RB1C) was created.

When vacuum injection was performed on the resulting secondary cell RB1, the secondary cell was evacuated down to 90 kPa to check for its airtightness; then the electrolyte was injected. It was found that when evacuated down to 90 kPa, the secondary cell RB1, in which a lid member and an exterior case having a plate thickness of 0.8 mm were double-seamed with a corner R measuring 15 mm, maintains its vacuum state over a long period of time and no external air enters through the sealed section. In other words, the secondary cell RB1 has high airtightness.

### Example 1

A secondary cell RB1A structure according to the aforementioned first embodiment shown in FIG. 2 was adopted, and a design was employed so that a corner R20 was present. The secondary cell was double-seamed and sealed. In this process, a polyolefin-based sealing agent having resistance against the electrolyte was applied on the seamed portion, and double-seaming was performed.

### Example 2

A secondary cell RB1B structure according to the aforementioned second embodiment shown in FIG. 3 was employed, a canister structure in which the seamed sections bulge in the longitudinal direction was employed, and a design was employed so that a corner R20 was present. The secondary cell was double-seamed and sealed. In this process, a polyolefin-based sealing agent having resistance against the electrolyte was applied on the seamed portion, and double-seaming was performed.

### Example 3

A secondary cell RB1C structure according to the aforementioned third embodiment shown in FIG. 4 was employed, a canister structure in which the seamed sections bulge primarily in the lateral direction was employed, and a designed was employed so that a corner R20 was present. The secondary cell was double-seamed and sealed. In this process, a polyolefin-based sealing agent having resistance against the electrolyte was applied on the seamed portion, and double-seaming was performed.

The secondary cells obtained in the first through third examples were charged up to 3.5 V at a constant current and constant voltage at 30 A for 5 hours. After a pause of 10 minutes, the cells were discharged to 2.5 V at a constant current of 30 A, and initial measurement of the cell capacity was performed. Next, a cycle evaluation was performed in which a constant-current constant-voltage charge at 100 A for 2 hours up to 3.5 V, a 10-minute pause, a constant-current discharge at 150 A up to 2 V, and a 10-minute pause, were repeated. The retention capacity after 500 cycles was divided by the initial retention capacity, and the cycle retention rate was measured. The results of the measurement are shown in Table 1.

TABLE 1

| | Cycle retention rate |
|---|---|
| Example 1 | 99% |
| Example 2 | 97% |
| Example 3 | 98% |

As can be seen from the measurement results shown in Table 1, a high cycle retention rate equal to or greater than 97% is maintained in all of the configurations according to the first through third examples. In particular, a high cycle retention rate of 99% is presented in the first example configured so that four sides of the electrode group accommodating part bulge outward. Thus, even for a cell canister made from a plate having a plate thickness of 0.8 mm, by double-seaming the peripheral edge sections at a corner R that is larger than the bend r, it is possible to obtain a secondary cell exhibiting an excellent cycle retention rate.

As described above, in the secondary cell according to the present embodiments, the peripheral edge sections of the exterior case and the lid member are double-seamed at an appropriately sized corner R exhibiting airtightness; therefore it is possible to obtain a cell canister in which airtightness is enhanced.

The electrode group accommodating part is substantially cuboid, and an appropriately sized corner R is formed so as to surround the periphery of the electrode group accommodating part. Therefore, no restrictions are placed on the size of the positive electrode plate and the negative electrode plate, a sufficient amount of the electrolyte can be introduced, and the energy density is increased. The secondary cells can also be readily stacked in the vertical direction.

Since the peripheral edge sections of the exterior case and the lid member are continuously double-seamed and sealed, sealing work can be facilitated, production takt time can be improved, and productivity can be enhanced. It is also possible to obtain a secondary cell that can be readily handled by holding the double-seamed section or the bulging section.

Specifically, according to the present invention, peripheral edge sections are provided so as to bulge outward from a substantially cuboid electrode group accommodating part, and the bulging peripheral edge sections are double-seamed at a corner R that is larger than a bend r of an exterior case; therefore, it is possible to form double-seamed sections that can exhibit a predetermined degree of airtightness, maintain a high energy density, and increase the cell capacity. Also, since the secondary cell has a large corner R, it is possible to perform double-seaming work rapidly. The secondary cell can also be readily carried by holding the outwardly bulging double-seamed sections. In other words, it is possible to obtain a secondary cell in which the production takt time can be improved, airtightness in a cell canister can be obtained, the cell capacity can be increased, and the handling properties are excellent.

### INDUSTRIAL APPLICABILITY

Therefore, the secondary cell according to the present invention can be suitably used for a storage battery in which there is a need to combine a plurality of secondary cells having a predetermined size and increase the capacity.

What is claimed is:

1. A secondary cell, comprising:
an electrode group obtained by layering a positive electrode plate, a negative electrode plate, and a separator;
an exterior case for accommodating the electrode group, and a lid member for hermetically sealing the exterior case; and
a cell canister configured using the exterior case and the lid member, an interior of the cell canister being filled with an electrolyte;
the cell canister having a substantially cuboid electrode group accommodating part, and a peripheral edge section in which the exterior case and the lid member are double-seamed and sealed; and
the peripheral edge section being provided so as to bulge outward from the electrode group accommodating part, and having a corner R that is greater than a bend r of a corner section of the exterior case.

2. The secondary cell according to claim 1,
the corner R being equal to or greater than double the bend r.

3. The secondary cell according to claim 1,
the corner R being a corner R corresponding to the plate thickness of the double-seamed exterior case and lid member, and exhibiting airtightness.

4. The secondary cell according to claim 1,
a double-seamed section provided so as to bulge outward from the electrode group accommodating part and protrude upward, and forming a step having a predetermined chuck wall height and being of a size allowing the electrode group accommodating part to fit therein.

5. The secondary cell according to claim 1,
the peripheral edge section being provided upon four peripheral sides of the electrode group accommodating part being extended.

6. The secondary cell according to claim 1,
the cell canister having an electrode group accommodating part provided with positive and negative external terminals installed respectively on two opposing side surfaces, the electrode group accommodating part fashioned to a rectangular profile having long sides and short sides; and
the peripheral edge section being provided upon primarily the short sides to which the external terminals are provided being extended.

7. The secondary cell according to claim 1,
the cell canister having an electrode group accommodating part provided with positive and negative external terminals installed respectively on two opposing side surfaces, the electrode group accommodating part fashioned to a rectangular profile having long sides and short sides; and
the peripheral edge section being provided upon primarily the long sides to which the external terminals are not provided being extended.

8. The secondary cell according to claim 1,
the plate thickness of the exterior case and the plate thickness of the lid member being a thickness of about 0.8 to 1.0 mm at which predetermined cell canister strength is exhibited, the corner R being about 15 mm or more.
